(19) United States
(12) Patent Application Publication
(10) Pub. No.: US 2021/0330011 A1
(43) Pub. Date: Oct. 28, 2021

(54) SWATCH

(71) Applicant: Stephanie L. Cole, Rapid, SD (US)

(72) Inventor: Stephanie L. Cole, Rapid, SD (US)

(21) Appl. No.: 17/303,037

(22) Filed: Jul. 4, 2021

Related U.S. Application Data
(60) Provisional application No. 60/195,475, filed on Apr. 10, 2000.

(51) Int. Cl. A41G 5/00

(52) U.S. Cl. CPC A41G 5/0046

(57) ABSTRACT

The Swatch is an Educational Beauty Apparatus providing a fabric material that is attached to a synthetic or natural hair extension. The hair extension attached to the fabric is not used as a hair extension to alter appearance but used as a guide in the color consultation process. Each Swatch will vary in different shades of hair color, shades of highlights and low-lights, and act as the precise foil placement. The Swatch will be placed over the guests' head using a wig cap or plastic cap for sanitation purposes. The Swatch can be hand washed and air dried with no heat.

The Swatch invention presented before you by Stephanie L. Cole. The Swatch is designed as an Educational Beauty Apparatus for me and my fellow colleagues in the beauty industry. The Swatch is designed using a hair extension and fabric, and a sewing technique or adhesion in the application for the design. The Swatch is made for Color/Highlight/Lowlight application for the Color Consultation Process.

### Full Color Swatch

Includes Color Shades ranging from levels 1-10. This swatch is considered your base color or all-over solid color choice.

### Foil Placement

This will be used for deciding the proper measurement between your foiling sub-sections. The sub-sections from ¼ inch, ½ inch, 1 inch will offer precise dimension application.

### Foil Technique Swatch

Will show how the foils will look for added dimension with the guest's base color choice. The Swatch will be placed over the guest head to decide future color and foiling technique. the Swatch is used as an educational guide for the stylist to apply proper color and foil placement for their clients desired color results. The Swatch is a vital tool that can be used in the Color Consultation Process. The Watch educates both stylist and guest by guiding them to find the perfect shade for their guest's beauty needs.

### DESCRIPTION

### Technical Field

The Swatch pertains the Beauty Industry to be used as an Educational Apparatus to help stylist and client find the perfect hair color end result.

### Background and Summary of the Invention

The Swatch is an educational apparatus to teach and guide stylist and client through the color consultation process. The level and tone of each swatch will compliment clients skin tone and eye color without have to guess the target levels. The stylist will become more confident in color chemistry and their color wheel formulation. The client will feel more confident and comfortable knowing which colors work best on them.

### BRIEF DESCRIPTION OF DRAWINGS

FIG. 1 shows the fabric or flexible tool for the adhesion of the extension.

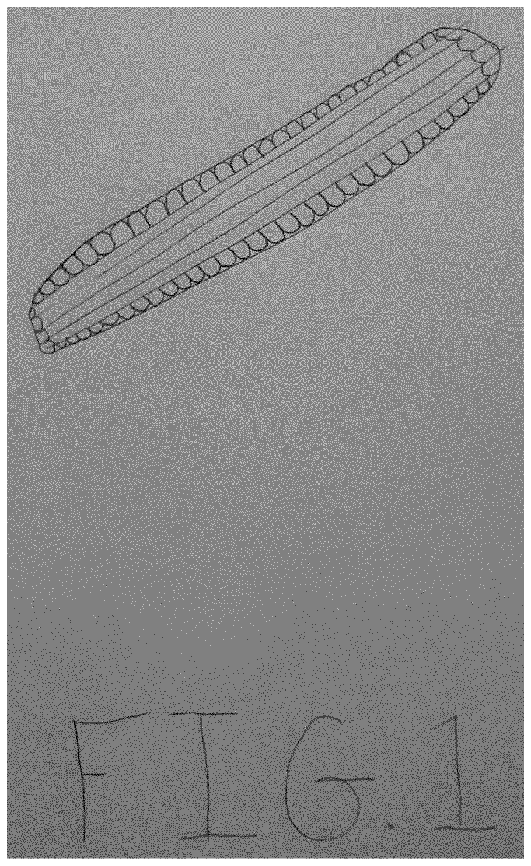

FIG. 2 shows the extension used, synthetic or human hair is used to build the Educational Beauty Apparatus.

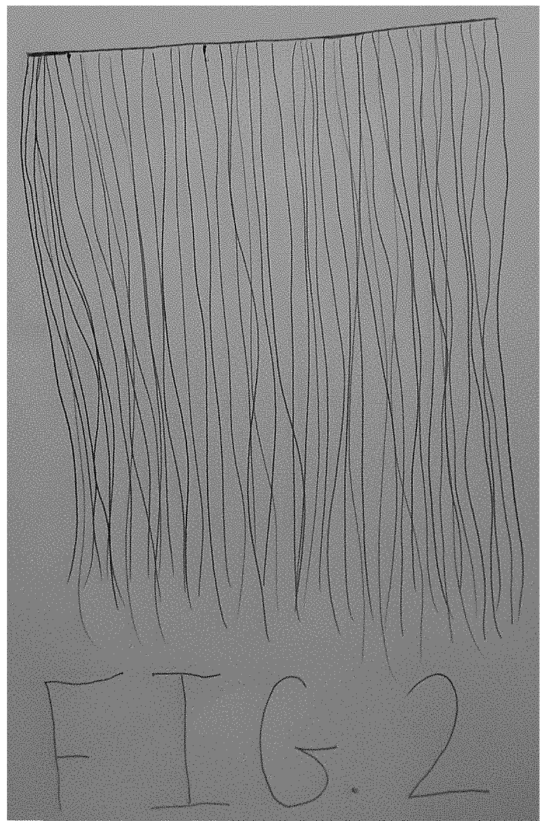

FIG. 3 shows a solid shade of extension used in any hair color made as a target level for your client.

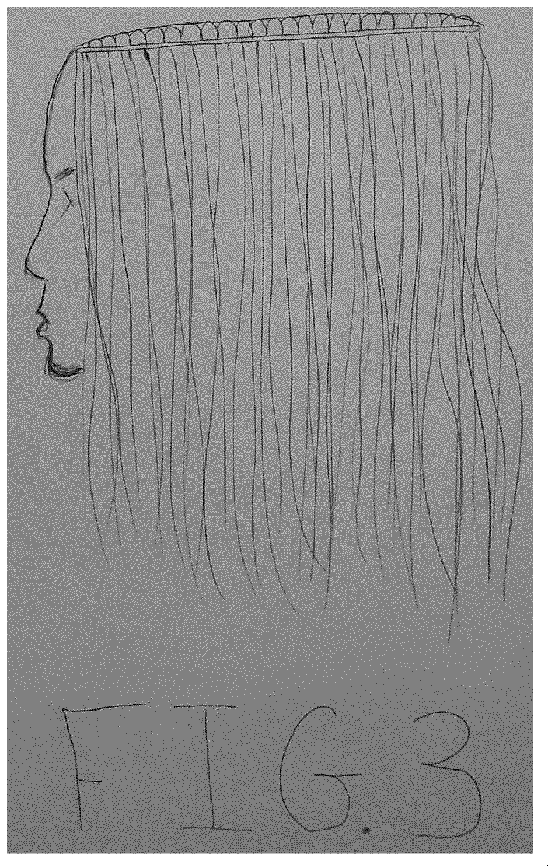

FIG. 4 shows highlight and lowlight technique with different measure placement. FIG. 4a. shows the sectioning being ½ inch to 1-inch partings. FIG. 4b. Shows ¼ inch foil sections.

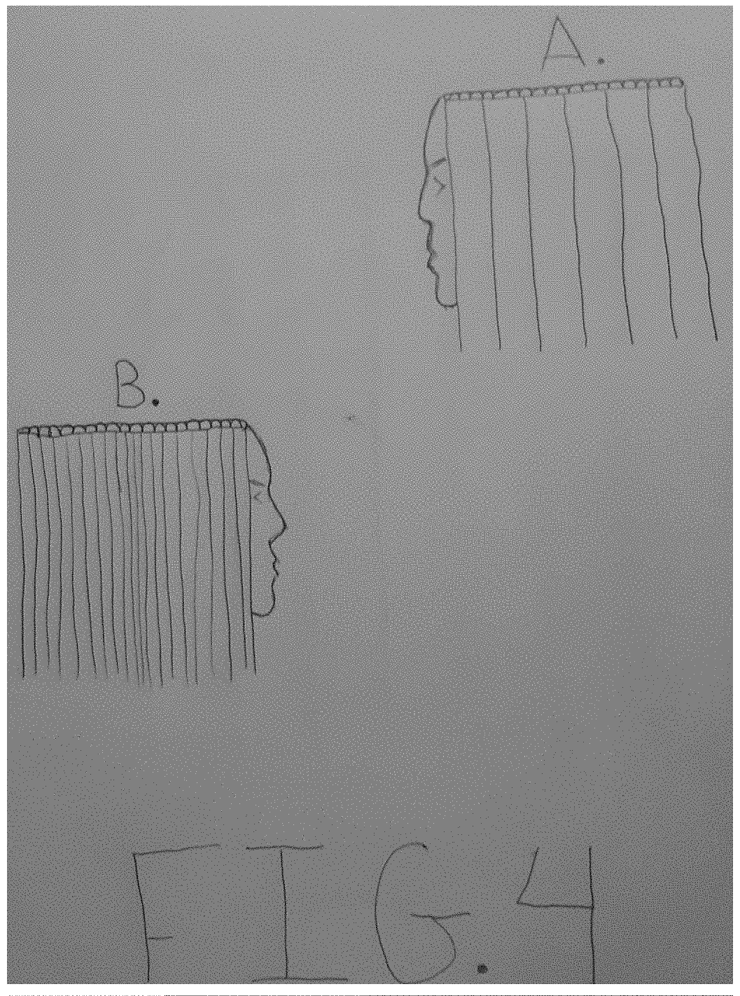

FIG. 5 shows the combination of The Swatch used when a solid color is chosen and when the highlight and lowlight swatch is chosen.

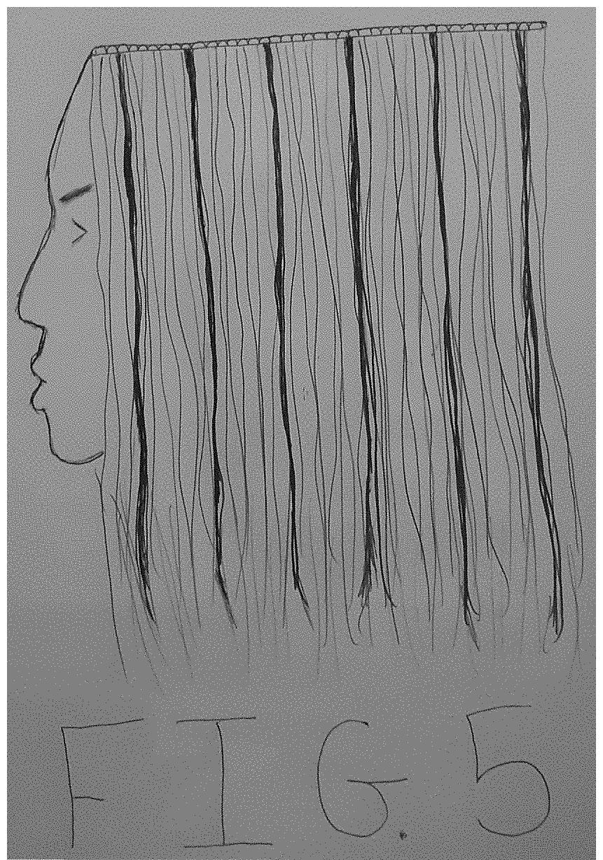

1. The Swatch is an Educational Beauty Apparatus, it is a non-adhesive device made for visual learners on how to guide themselves to reach their clients desired haircolor results compromising of:
fabric of 4-6 inches in length, fabric is then glued or sewn to the hair extension that is adhered in an oval shape onto the fabric, then is placed over their guest, you can start using the different solid shaded swatches to determine future color target level;
the swatch offers solid shade hair color, highlight and lowlight swatches, the highlight and lowlight swatches are attached to the fabric in ¼ inch sections, ½ inch sections, 1 inch sections to show the guest how their highlights and lowlights will look when they are applied in a precise measured foil technique.
